(19) United States
(12) Patent Application Publication
(10) Pub. No.: US 2023/0364785 A1
(43) Pub. Date: Nov. 16, 2023

(54) DEVICE FOR SEEKING WORKPIECE HOLDING FORM FOR ROBOT HAND AND METHOD THEREFOR

(71) Applicant: YAMAHA HATSUDOKI KABUSHIKI KAISHA, Iwata-shi, Shizuoka (JP)

(72) Inventor: Naoki HIDA, Iwata-shi, Shizuoka (JP)

(73) Assignee: YAMAHA HATSUDOKI KABUSHIKI KAISHA, Iwata-shi, Shizuoka (JP)

(21) Appl. No.: 18/043,297

(22) PCT Filed: Oct. 28, 2020
(86) PCT No.: PCT/JP2020/040531

§ 371 Date: Feb. 27, 2023

(51) Int. Cl. B25J 9/16

(52) U.S. Cl. CPC B25J 9/1612; B25J 9/163; B25J 9/1664

(57) ABSTRACT

A device for seeking a workpiece holding form for a robot hand and a method for seeking a workpiece holding form executes a predetermined number of times a process for generating a holding form to hold the workpiece with the robot hand based on a mounted state of the workpiece, holding the workpiece with the robot hand in the generated holding form, causing the robot hand to execute a predetermined movement thereafter, and then determining an evaluation score to evaluate the holding form while generating different holding forms.

### CROSS-REFERENCE TO RELATED APPLICATION

This application is a National Stage of International Patent Application No. PCT/JP2020/040531, filed Oct. 28, 2020, the entire content of which is incorporated herein by reference.

### BACKGROUND

### Technical Field

The present disclosure relates to a device for seeking a workpiece holding form for a robot hand and a method for seeking a workpiece holding form that can find a more suitable holding form when holding a workpiece with a robot hand.

### Background Art

In recent years, introduction of robots is progressing in various industrial fields for labor saving and efficiency improvement. For the introduction, one of important requirements is that a robot can certainly hold a workpiece with a robot hand. Examples of technology to hold a workpiece with a robot hand include the technology disclosed in Japanese Patent Application Laid-Open No. 2017-064910.

The machine learning device disclosed in Japanese Patent Application Laid-Open No. 2017-064910 is a machine learning device that learns an action of a robot to take out a workpiece with a hand unit from a plurality of randomly placed workpieces including a bulk state. The machine learning device includes a state quantity observation unit that observes output data of a three-dimensional measuring instrument that measures at least a three-dimensional map for each of the workpieces, an action result acquisition unit that acquires a result of the taking out action of the robot to take out the workpiece with the hand unit, and a learning unit that receives output from the state quantity observation unit and output from the action result acquisition unit and learns the taking out action of the workpiece. The state quantity observation unit further observes output data of a coordinate calculation unit that calculates the three-dimensional position of each of the workpieces based on the output of the three-dimensional measuring instrument. The learning unit (22) includes a reward calculation unit that calculates a reward based on a determination result of success or failure of taking out the workpiece that is the output of the action result acquisition unit, and a value function update unit that has a value function that determines the value of the taking out action of the workpiece and updates the value function according to the reward. According to Japanese Patent Application Laid-Open No. 2017-064910 described above, the machine learning device can learn, without human intervention, the optimal action of the robot when taking out the workpiece that is randomly placed including a bulk state, and can take out the workpiece from the plurality of randomly placed workpieces with the hand unit.

Meanwhile, for example, if the workpiece has a moving part or a rotating shaft, such as a stuffed toy, doll, scissors, and book, there is a risk that after the robot hand grips the workpiece, the orientation or shape of the workpiece may change. For example, if the workpiece is slippery with low frictional force points, such as a bolt, can, and bottle, or if the workpiece is prone to rotation or displacement, such as a box with an unbalanced center of gravity, there is a risk that after the robot hand grips the workpiece, the orientation of the workpiece may change.

If the orientation or shape of the workpiece changes after the robot hand grips the workpiece, for example, when assembling the workpiece, a trouble occurs in the positioning, making the assembly difficult. For example, if the workpiece is placed at a predetermined place by the robot hand, the workpiece is no longer placed in the assumed orientation because of the orientation change. Therefore, there is a risk that the robot hand in the next step may not be able to grip the workpiece or that the degree of freedom in the way of gripping may be reduced.

The machine learning device disclosed in Japanese Patent Application Laid-Open No. 2017-064910 described above can take out the workpiece from the plurality of randomly placed workpieces with the hand unit, but does not take into account the orientation change of the workpiece after gripping.

### SUMMARY

The present disclosure has been made in view of the above circumstances, and provides a device for seeking a workpiece holding form for a robot hand and a method for seeking a workpiece holding form that can find a way to hold the workpiece that can reduce the orientation change of the workpiece after gripping when holding the workpiece with the robot hand.

A device for seeking a workpiece holding form for a robot hand and a method for seeking a workpiece holding form according to the present disclosure executes a predetermined number of times a process for generating a holding form to hold the workpiece with the robot hand based on a mounted state of the workpiece, holding the workpiece with the robot hand in the generated holding form, causing the robot hand to execute a predetermined movement thereafter, then determining an evaluation score to evaluate the holding form while generating different holding forms. With this process, the device for seeking a workpiece holding form for a robot hand and the method can determine the plurality of evaluation scores for various plurality of holding forms for the mounted state of the workpiece, and therefore can find the holding form that can reduce the orientation change of the workpiece after gripping for the mounted state of the workpiece when holding the workpiece with the robot hand.

The above as well as additional objects, features, and advantages of the present disclosure will become apparent from the following detailed description and the accompanying drawings.

### BRIEF DESCRIPTION OF THE DRAWINGS

FIG. 1 is a block diagram showing a configuration of a device for seeking a workpiece holding form for a robot hand in an embodiment;

FIG. 2 is a diagram for describing one example of evaluation scores used in the device for seeking a workpiece holding form;

FIG. 3 is a flow chart showing an overall action of the device for seeking a workpiece holding form regarding calculation of the evaluation score and machine learning;

FIG. 4 is a flow chart showing an action of the device for seeking a workpiece holding form regarding calculation of the evaluation score;

FIG. 5 is a diagram for describing how a workpiece is held with the robot hand;

FIGS. 6A and 6B are diagrams for describing feature points set for the workpiece;

FIGS. 7A and 7B are diagrams for describing a method for calculating the evaluation score when there is no orientation change as one example;

FIGS. 8A and 8B are diagrams for describing the method for calculating the evaluation score when there is an orientation change as another example;

FIGS. 9A to 9C are diagrams for describing a variation to restrict a portion in which the evaluation score is determined for the workpiece;

FIGS. 10A and 10B are diagrams for describing the method for calculating the evaluation score when there is no orientation change in the restricted portion as one example;

FIGS. 11A and 11B are diagrams for describing the method for calculating the evaluation score when there is an orientation change in the restricted portion as another example;

FIG. 12 is a diagram for describing a movement input screen in another variation to input and set a predetermined movement to be executed after holding the workpiece with the robot hand; and

FIG. 13 is a diagram for describing another variation to find a holding form in a series of robot actions.

### DETAILED DESCRIPTION

One or more embodiments of the present disclosure will be described below with reference to the drawings. However, the scope of the disclosure is not limited to the disclosed embodiments. Note that components with the same reference sign in respective drawings indicate the same component, and descriptions thereof will be omitted as appropriate. In this specification, when a component is generically called, the component is denoted with a reference sign with a subscript omitted, whereas when an individual component is referred to, the component is denoted with a reference sign with a subscript attached.

A device for seeking a workpiece holding form for a robot hand in the embodiment is a device that can find a holding form that is suitable for a mounted state of the workpiece placed when holding the workpiece with the robot hand. The device for seeking a workpiece holding form includes: a holding form generation unit that executes a holding form generation process to generate the holding form to hold the workpiece with the robot hand based on the mounted state of the workpiece; a hand control unit that executes a gripping process to hold the workpiece with the robot hand in the holding form generated by the holding form generation unit; a movement execution unit that executes a movement execution process to cause the robot hand to execute a predetermined movement after the robot hand holds the workpiece; an evaluation scoring unit that executes an evaluation scoring process to determine an evaluation score to evaluate the holding form after the movement execution unit causes the robot hand to execute the predetermined movement; and a repetitive processing unit that causes the holding form generation unit, the hand control unit, the movement execution unit, and the evaluation scoring unit to execute a predetermined number of times the holding form generation process, the gripping process, the movement execution process, and the evaluation scoring process, respectively. The holding form generation unit generates different holding forms in the execution of the predetermined number of times. In the present embodiment, the device for seeking a workpiece holding form includes a machine learning unit that executes machine learning on the holding form based on the holding form generated by the holding form generation unit and the evaluation score determined by the evaluation scoring unit. The repetitive processing unit further causes the machine learning unit to execute the machine learning in the execution of the predetermined number of times. Such a device for seeking a workpiece holding form will be described more specifically below.

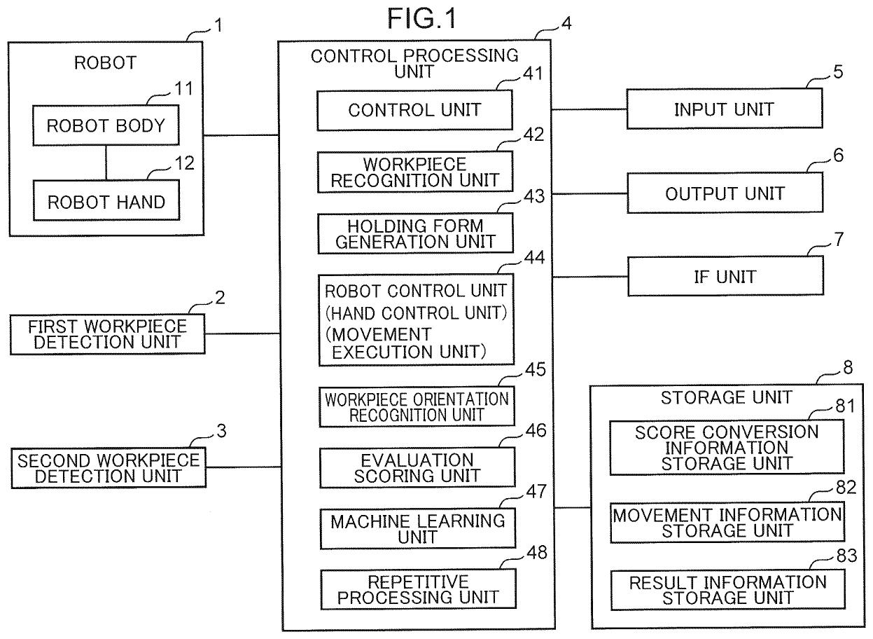

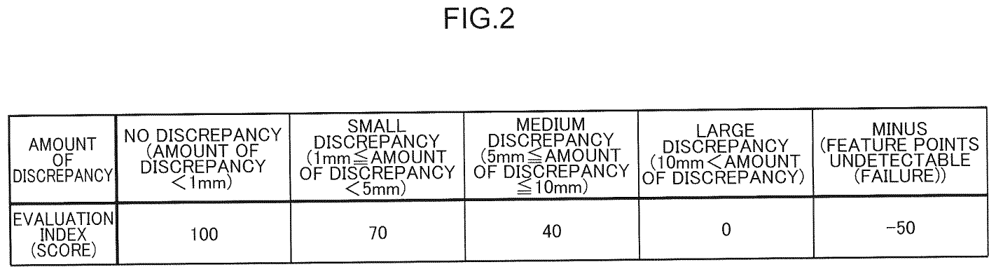

FIG. 1 is a block diagram showing a configuration of a device for seeking a workpiece holding form for a robot hand in the embodiment. FIG. 2 is a diagram for describing one example of evaluation scores used in the device for seeking a workpiece holding form.

The device for seeking a workpiece holding form for a robot hand (hereinafter abbreviated as “device for seeking a workpiece holding form” as appropriate) D in the embodiment includes, for example, as shown in FIG. 1, a robot 1, a first workpiece detection unit 2, a second workpiece detection unit 3, a control processing unit 4, an input unit 5, an output unit 6, an interface unit (IF unit) 7, and a storage unit 8.

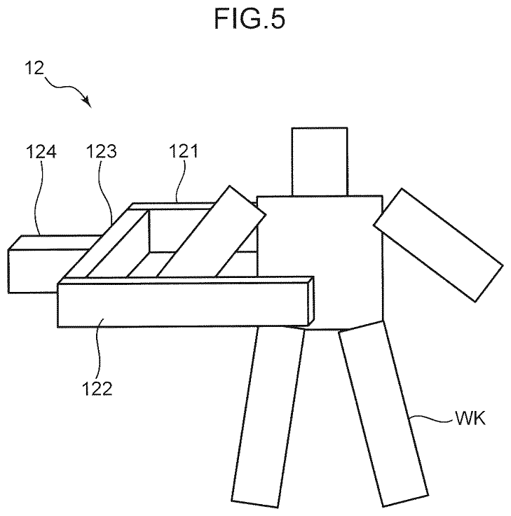

The robot 1 is a mechanical device that is connected to the control processing unit 4 and executes predetermined work (action, movement) in response to the control of the control processing unit 4, and includes, for example, a robot body 11 and a robot hand 12. The robot body 11 is, for example, a six-axis articulated robot that is connected to the control processing unit 4 and moves in response to the control of the control processing unit 4, and includes the robot hand 12 at a tip thereof. The robot hand 12 is a mechanism that is connected to the control processing unit 4 via the robot body 11 and can hold and release a workpiece WK in response to the control of the control processing unit 4. The robot hand 12 includes, for example, as shown in FIG. 5 described later, one pair of first and second finger parts 121 and 122, a support part 123 that supports these first and second finger parts, and a connection part 124 that connects the support part 123 to the tip of the robot body 11. In the example shown in FIG. 5, each of the first and second finger parts 121 and 122 is a plate-like member extending in one direction. To enable at least one end of each of the first and second finger parts 121 and 122 (for example, each tip) to be separated and connected, the support part 123 is connected to the other end of each of the first and second finger parts 121 and 122 (for example, each base portion). The robot hand 12 can hold the workpiece WK with predetermined gripping force by bringing one end of each of the first and second finger parts 121 and 122 close to each other, and can release the workpiece WK by separating one end of each of the first and second finger parts 121 and 122. One end of the connection part 124 is connected to the support part 123, and the other end, although not shown, is rotatably connected to the tip of the robot body 11. The robot hand 12 can rotate with respect to the robot body 11 with the connection part 124 as a rotation axis.

The first workpiece detection unit 2 is a device that is connected to the control processing unit 4 and detects the workpiece WK held by the robot hand 12 in response to the control of the control processing unit 4. The first workpiece detection unit 2 is, for example, an image capturing device (so-called digital camera), light detection and ranging (LiDAR), or the like.

The second workpiece detection unit 3 is a device that is connected to the control processing unit 4 and detects the workpiece WK placed on a mounting table in response to the control of the control processing unit 4. The second workpiece detection unit 3 is, for example, an image capturing device, a LiDAR, or the like, in a similar manner to the first workpiece detection unit 2. Therefore, one image capturing device, LiDAR, or the like may be used as both the first workpiece detection unit 2 and the second workpiece detection unit 3 by making the detection direction (image capturing direction or scanning direction) changeable.

The input unit 5 is a device that is connected to the control processing unit 4 and inputs, for example, various commands such as a command to instruct the device for seeking a workpiece holding form D to start action and various data necessary for the operation of the device for seeking a workpiece holding form D to the device for seeking a workpiece holding form D. The input unit 5 is, for example, a plurality of input switches to which predetermined functions are assigned, a keyboard, a mouse, and the like.

The output unit 6 is a device that is connected to the control processing unit 4 and outputs commands and data input from the input unit 5 and an evaluation score EV determined by holding the workpiece WK and executing a predetermined movement in response to the control of the control processing unit 4. The output unit 6 is, for example, a display device such as a CRT display, a liquid crystal display device (LCD), and an organic EL display, or a printing device such as a printer.

Note that the input unit 5 and the output unit 6 may include a touch panel. When the touch panel is included, the input unit 5 is, for example, a position input device that detects and inputs the operation position, such as a resistive film method or a capacitive method, and the output unit 6 is a display device. In this touch panel, a position input device is provided on a display surface of the display device, and one or more input content candidates that can be input are displayed on the display device. When a user touches the display position where the input content to be input is displayed, the position is detected by the position input device, and the display content displayed at the detected position is input to the device for seeking a workpiece holding form D as the user's operation input content. With such a touch panel, the user can intuitively understand the input operation easily, and therefore the device for seeking a workpiece holding form D that is easy for the user to handle is provided.

The IF unit 7 is, for example, a circuit that is connected to the control processing unit 4 and inputs and outputs data from and to an external device in response to the control of the control processing unit 4. The IF unit 7 is, for example, an interface circuit of RS-232C, which is a serial communication system, an interface circuit using the Bluetooth (registered trademark) standard, an interface circuit using the USB standard, and the like. The IF unit 7 may be, for example, a communication interface circuit for transmitting and receiving communication signals to and from an external device such as a data communication card, a communication interface circuit conforming to the IEEE 802.11 standard, and the like.

The storage unit 8 is a circuit that is connected to the control processing unit 4 and stores various predetermined programs and various predetermined data in response to the control of the control processing unit 4. The various predetermined programs include, for example, a control processing program and the like. The control processing program includes: a control program to control respective units 1 to 3 and 5 to 8 of the device for seeking a workpiece holding form D according to functions of each unit; a workpiece recognition program to recognize, for example, the mounted state of the workpiece WK placed on the mounting table or the like based on a detection result of the second workpiece detection unit 3; a workpiece orientation recognition program to recognize the orientation of the workpiece WK held by the robot hand 12 based on a detection result of the first workpiece detection unit 2; a holding form generation program to execute a holding form generation process to generate the holding form to hold the workpiece WK with the robot hand 12 based on the mounted state of the workpiece WK; a robot control program to execute a gripping process to hold the workpiece WK with the robot hand 12 in the holding form generated by the holding form generation program, and to execute a movement execution process to cause the robot hand 12 to execute predetermined movement after holding the workpiece WK with the robot hand 12; an evaluation scoring program to execute an evaluation scoring process to determine the evaluation score EV to evaluate the holding form after causing the robot hand 12 to execute the predetermined movement with the robot control program; a repetitive processing program to execute a predetermined number of times the holding form generation process, the gripping process, the movement execution process, and the evaluation scoring process; and the like. In the present embodiment, the control processing program further includes a machine learning program to execute machine learning on the holding form based on the holding form generated by the holding form generation program, the predetermined movement, and the evaluation score determined by the evaluation scoring program. The repetitive processing program further causes the machine learning program to execute machine learning in the execution of the predetermined number of times. The various predetermined data include data necessary for executing each program, such as score conversion information, movement information, and result information. The storage unit 8 includes, for example, a read only memory (ROM), which is a non-volatile memory element, an electrically erasable programmable read only memory (EEPROM), which is a rewritable non-volatile memory element, and the like. The storage unit 8 may include a relatively large-capacity hard disk drive. The storage unit 8 includes a random access memory (RAM) that is a so-called working memory for the control processing unit 4 to store data and the like generated during execution of the predetermined program, and the like. Then, in order to store each of the score conversion information, movement information, and result information. The storage unit 8 functionally includes a score conversion information storage unit 81, a movement information storage unit 82, and a result information storage unit 83.

The score conversion information storage unit 81 stores the score conversion information. The score conversion information is information used when determining the evaluation score EV for evaluating the holding form. In the present embodiment, the evaluation score EV is determined based on the orientation before movement, which is the orientation of the workpiece WK before executing the predetermined movement, and the orientation after movement, which is the orientation of the workpiece WK after executing the predetermined movement. More specifically, the evaluation score EV is determined based on an amount of discrepancy between the orientation after movement and the orientation before movement. Therefore, the score conversion information may be information that associates the amount of discrepancy between the orientation before movement and the orientation after movement with the value of the evaluation score EV, but in the present embodiment, since the evaluation score EV is determined by being weighted with weight WT, the score conversion information is information that associates the amount of discrepancy between the orientation before movement and the orientation after movement with the value of evaluation score ev before the weighting. The score conversion information may be stored in the score conversion information storage unit 81 by being incorporated into the evaluation scoring program, or may be stored in the score conversion information storage unit 81 by being input by the user (operator) from the input unit 5. In one example, as shown in FIG. 2, when there is almost no amount of discrepancy ((amount of discrepancy)<1 [mm]), the evaluation score ev is 100, when the amount of discrepancy is small (1 [mm]<(amount of discrepancy)<5 [mm]), the evaluation score ev is 70, when the amount of discrepancy is medium (5 [mm]≤(amount of discrepancy)≤10 [mm]), the evaluation score ev is 40, when the amount of discrepancy is large (10 [mm], (amount of discrepancy)), the evaluation score ev is 0, when the robot hand 12 fails to grip or drops the workpiece WK to disable detection of the amount of discrepancy (feature points undetectable (failure)), the evaluation score ev is −50.

The movement information storage unit 82 stores movement information representing the predetermined movement. The predetermined movement includes, for example, at least one of a speed movement to move the robot hand 12 in one predetermined direction at a predetermined speed for a predetermined time, an acceleration movement to move the robot hand 12 in one predetermined direction at predetermined acceleration for a predetermined time, a rotational movement to rotate the robot hand 12 in a predetermined angular range at a predetermined speed (or predetermined angular speed) or predetermined acceleration (or predetermined angular acceleration) for a predetermined time, and a vibration movement to vibrate the robot hand at predetermined amplitude and frequency (or cycle) for a predetermined time. When the predetermined movement is the speed movement, the movement information is one predetermined direction, predetermined speed, and predetermined time. When the predetermined movement is the acceleration movement, the movement information is one predetermined direction, predetermined acceleration, and predetermined time. When the predetermined movement is the rotational movement, the movement information is predetermined amplitude, predetermined speed (predetermined angular speed), or predetermined acceleration (predetermined angular acceleration and predetermined time). When the predetermined movement is the vibration movement, the movement information is predetermined amplitude, predetermined frequency, and predetermined time. The movement information is set appropriately in advance and stored in the movement information storage unit 82.

The result information storage unit 83 stores the result information. The result information is a mounted state, holding form, and movement (action in operation) of the workpiece generated (obtained) when the robot 1 is actually operated after machine learning as described later. The result information storage unit 83 associates these pieces of information with each other and stores the information as the result information. The holding form is represented (defined) by the gripping position and the gripping force when gripping the workpiece WK with the robot hand 12.

The control processing unit 4 is a circuit for controlling respective units 1 to 3 and 5 to 8 of the device for seeking a workpiece holding form D according to functions of each unit, determining the evaluation score EV in various holding forms, and further executing machine learning in the present embodiment. The control processing unit 4 includes, for example, a central processing unit (CPU) and peripheral circuits thereof. By execution of the control processing program, the control processing unit 4 functionally includes a control unit 41, a workpiece recognition unit 42, a holding form generation unit 43, a robot control unit 44, a workpiece orientation recognition unit 45, an evaluation scoring unit 46, a machine learning unit 47, and a repetitive processing unit 48.

The control unit 41 controls respective units 1 to 3 and 5 to 8 of the device for seeking a workpiece holding form D according to functions of each unit and has overall control over the device for seeking a workpiece holding form D.

The workpiece recognition unit 42 recognizes, for example, the mounted state of the workpiece WK placed on the mounting table or the like based on the detection result of the second workpiece detection unit 3. For example, when the second workpiece detection unit 3 is an image capturing device, the workpiece recognition unit 42 detects an outline of the workpiece WK and recognizes the mounted state of the workpiece WK by extracting an edge from an image of the workpiece WK captured by the image capturing device (first workpiece image).

The holding form generation unit 43 executes the holding form generation process to generate the holding form to hold the workpiece WK with the robot hand 12 based on the mounted state of the workpiece WK. For example, the holding form generation unit 43 generates the holding form (gripping position and gripping force) by setting the gripping position to randomly grip the workpiece WK with the robot hand 12 for the mounted state of the workpiece WK within the gripping range in which the robot hand 12 can grip the workpiece (range equal to or less than the maximum interval of the first and second finger parts 121 and 122 in the example shown in FIG. 5) and by setting the gripping force to hold the workpiece WK with the robot hand 12 randomly within the gripping force range in which the robot hand 12 can grip the workpiece.

The robot control unit 44 controls the robot 1 to allow the robot 1 to execute predetermined work. The predetermined work includes the gripping process for holding the workpiece WK with the robot hand 12 in the holding form generated by the holding form generation unit 43, and the movement execution process for causing the robot hand 12 to execute predetermined movement represented by the movement information stored in the movement information storage unit 82 after holding the workpiece WK with the robot hand 12. That is, in the present embodiment, the robot control unit 44 executes the gripping process and executes the movement execution process. Note that the robot control unit 44 corresponds to one example of a hand control unit that executes the gripping process for holding the workpiece with the robot hand in the holding form generated by the holding form generation unit, and also corresponds to one example of a movement execution unit that executes the movement execution process for causing the robot hand to execute predetermined movement after holding the workpiece with the robot hand.

The workpiece orientation recognition unit 45 recognizes the orientation of the workpiece WK held by the robot hand 12 based on the detection result of the first workpiece detection unit 2. For example, when the first workpiece detection unit 2 is an image capturing device, the workpiece orientation recognition unit 45 detects the outline of the workpiece WK and recognizes the orientation of the workpiece WK by extracting the edge from the image of the workpiece WK captured by the image capturing device (second workpiece image). In the present embodiment, since the evaluation score EV is determined based on the amount of discrepancy at each of the plurality of feature points SM set for the workpiece WK as will be described later, the workpiece orientation recognition unit 45 recognizes the orientation of the workpiece WK by extracting the plurality of feature points SM from the outline of the workpiece WK and determining the position of each of the plurality of feature points SM. The plurality of feature points SM is appropriately set to be able to express the orientation of the workpiece WK. For example, the feature point is set for each movable part of the workpiece WK. Note that the first workpiece detection unit 2 and the workpiece orientation recognition unit 45 correspond to one example of an orientation detection unit that detects the orientation of the workpiece held by the robot hand. In the present embodiment, the workpiece orientation recognition unit 45 further determines whether the robot hand 12 is gripping the workpiece WK. The workpiece orientation recognition unit 45 can determine whether the robot hand 12 is gripping the workpiece WK, for example, by determining whether the workpiece WK (part or all of the workpiece WK) appears in the image of the workpiece WK captured by the image capturing device. In this case, the shape of the workpiece WK is stored in advance in the storage unit 8, the image of the workpiece WK is searched for the shape of the workpiece WK, and the shape of the workpiece WK is used to determine whether the workpiece WK appears in the image of the workpiece WK.

The evaluation scoring unit 46 executes the evaluation scoring process to determine the evaluation score EV to evaluate the holding form after the robot control unit causes the robot hand 12 to execute the predetermined movement. More specifically, in the present embodiment, the evaluation scoring unit 46 determines the evaluation score EV based on the orientation before movement and the orientation after movement. The orientation before movement is the orientation of the workpiece WK recognized by the workpiece orientation recognition unit 45 based on the detection result of the first workpiece detection unit 2 before executing the predetermined movement. The orientation after movement is the orientation of the workpiece WK recognized by the workpiece orientation recognition unit 45 based on the detection result of the first workpiece detection unit 2 after executing the predetermined movement. In more detail, the evaluation scoring unit 46 determines the amount of discrepancy between the orientation after movement and the orientation before movement, and converts the determined amount of discrepancy into the evaluation score EV. In the present embodiment, the plurality of feature points SM for determining the evaluation score EV is set for the workpiece WK. The weight WT when determining the evaluation score EV is set for each of the plurality of feature points SM from the point of view that each feature point SM has a different degree of importance according to the work purpose of the robot 1, such as a part of the workpiece WK that is difficult to allow the orientation change and a part of the workpiece WK that is easy to allow the orientation change. Each evaluation score EV is determined for each of the plurality of feature points SM by using the weight WT. Therefore, in the present embodiment, for each of the plurality of feature points SM, the evaluation scoring unit 46 determines the amount of discrepancy between the position of the feature point SM in the orientation before movement of the workpiece WK recognized by the workpiece orientation recognition unit 45 and the position of the feature point SM in the orientation after movement of the workpiece WK recognized by the workpiece orientation recognition unit 45 corresponding to each other. The evaluation scoring unit 46 converts the determined amount of discrepancy of the feature point SM into the evaluation score ev before weighting by using the score conversion information stored in the score conversion information storage unit 81, thereby determining a plurality of temporary evaluation scores EVt at the plurality of feature points SM. Then, for each of the plurality of feature points SM, the evaluation scoring unit 46 determines the evaluation score EV at each of the plurality of feature points SM by multiplying the temporary evaluation score EVt at the feature point SM by the weight WT corresponding to the feature point SM. Furthermore, in the present embodiment, the evaluation scoring unit 46 determines an average of the evaluation scores EV determined at the plurality of feature points SM as a final evaluation score EVr.

The machine learning unit 47 executes machine learning on the holding form based on the holding form generated by the holding form generation unit 43, the predetermined movement, and the evaluation score EV determined by the evaluation scoring unit 46 (final evaluation score EVr in the present embodiment). In the present embodiment, reinforcement learning of so-called Q-learning is used for machine learning. Reinforcement learning maximizes the future value rather than a current reward. Q-learning is generally represented by the following Formula 1.

$$\begin{matrix}[ Formula 1 ] & \\ ↵ Q ( s , a ) ← Q ( s , a ) + α ( R ( s , a ) + γ {max}_{{a}^{′}} Q ( {s}^{′} , {a}^{′} ) - Q ( s , a ) ) & Formula 1\end{matrix}$$

S: State (predetermined movement).
A: Action (holding form (gripping position, gripping force)).
R: Reward (final evaluation score).
a: Learning rate (0≤α≤1, ex 0.1).
Y: Discount rate (0≤γ≤0.1, ex 0.9).

Here, Q(s, a) is a value when an action a is taken in a state s (Q value). s is a state at time t, and s′ is a state at time t+1. a is an action at time t, and a′ is an action at time t+1. The state s changes to the state s′ by the action a. R(s, a) is a reward obtained by the state change (reward obtained when the action a is taken in the state s). maxQ(s′, a′) with a′ attached to the lower portion is the maximum value currently estimated. a is a learning rate (0≤α≤1), and γ is a discount rate (0≤γ≤1).

In the present embodiment, Q-learning is used by assigning the predetermined movement to the state s, assigning the holding form (gripping position and gripping force) to the action a, and assigning the final evaluation score EVr to the reward R. The learning rate a and the discount rate γ are set as appropriate. For example, the learning rate a is set to 0.1, 0.2, or the like, and the discount rate γ is set to 0.8, 0.9, or the like.

In the machine learning unit 47, a machine learning model is generated by the machine learning to output the holding form for the mounted state of the workpiece WK and the predetermined movement.

The repetitive processing unit 48 executes a predetermined number of times (number of times of evaluation, number of times of machine learning) the holding form generation process, the gripping process, the movement execution process, and the evaluation scoring process. In the present embodiment, furthermore, the repetitive processing unit 48 further causes the machine learning unit 47 to execute machine learning in the execution of the predetermined number of times. The holding form generation unit 43 generates different holding forms in the execution of the predetermined number of times. In the present embodiment, as described above, since the holding form is generated randomly, different holding forms are generated in the execution of the predetermined number of times. Note that since the holding form is generated randomly, it is possible that the same holding form is generated by chance, which can be ignored by increasing the number of times the processes are repeatedly executed.

The control processing unit 4, the input unit 5, the output unit 6, the IF unit 7, and the storage unit 8 in the device for seeking a workpiece holding form D can be configured by using, for example, a tower or desktop computer.

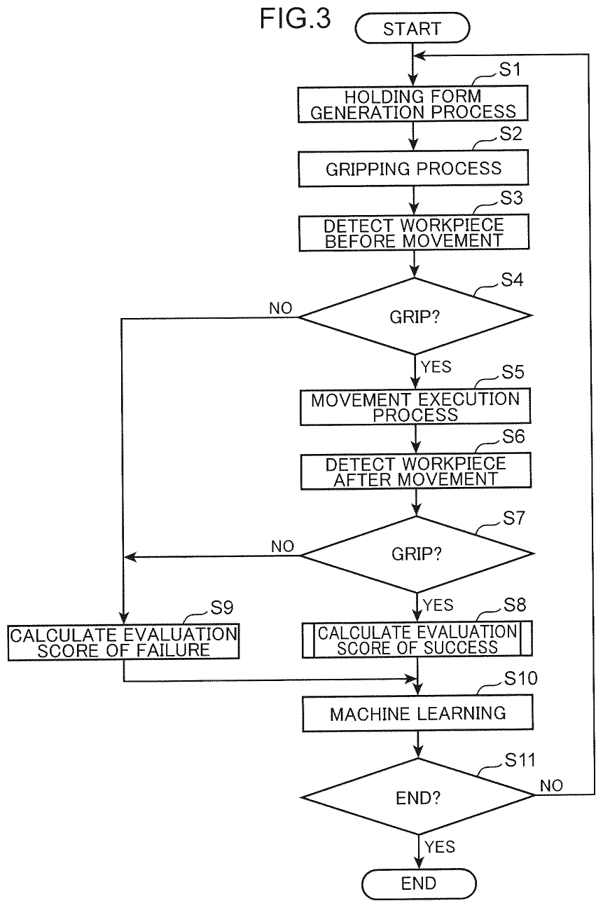

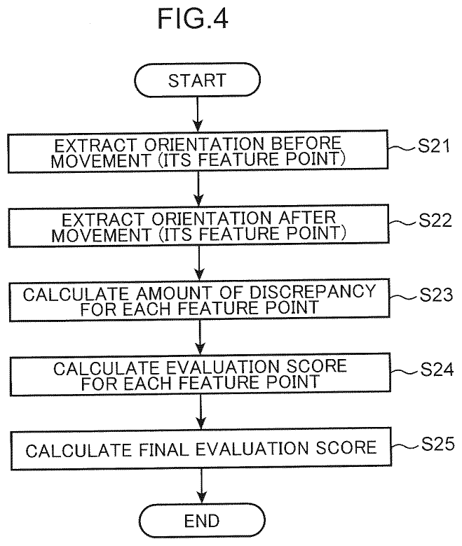

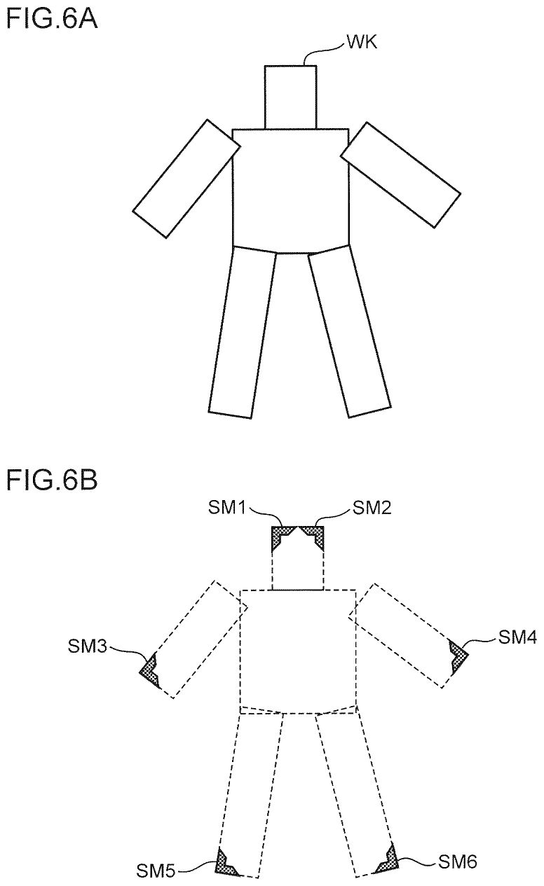

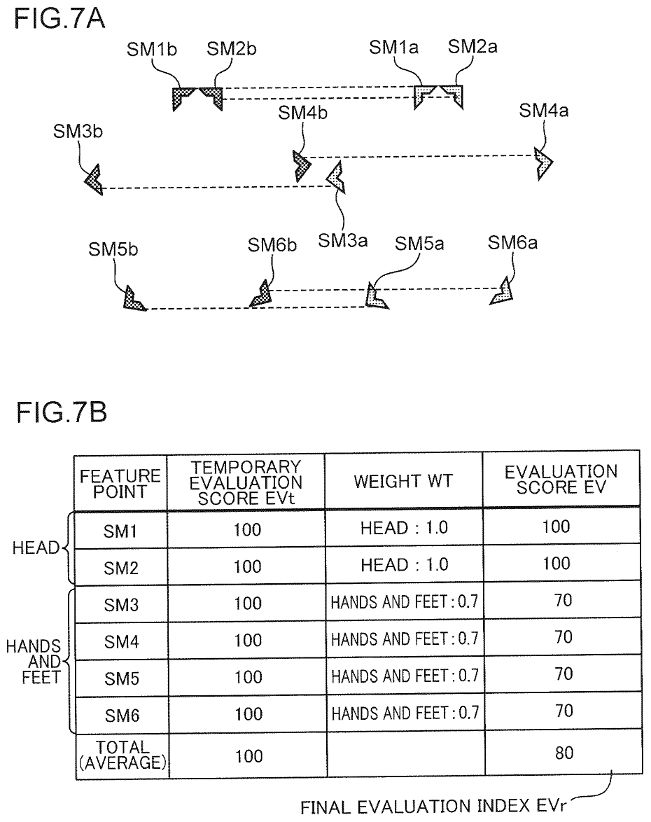

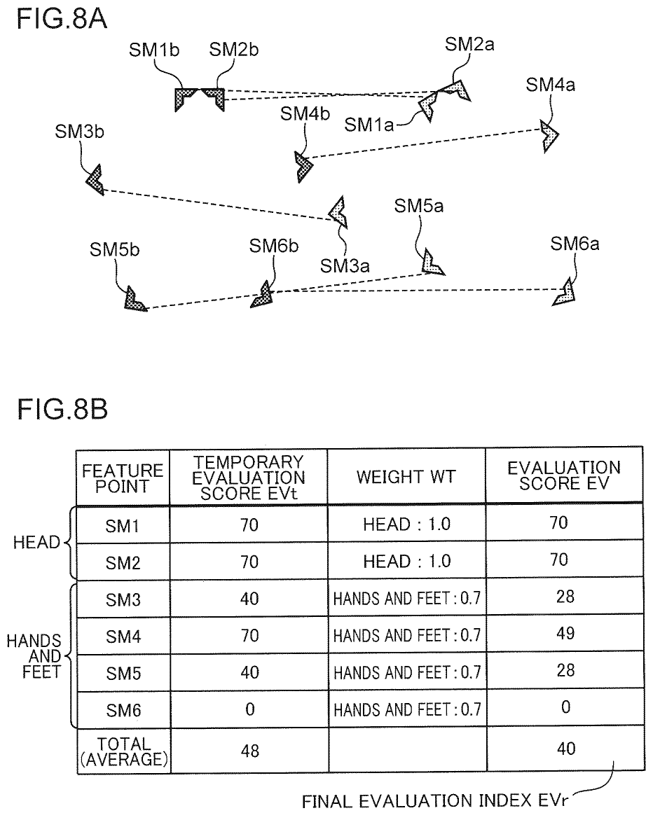

Next, the action of the device for seeking a workpiece holding form D will be described. FIG. 3 is a flow chart showing an overall action of the device for seeking a workpiece holding form regarding calculation of the evaluation score and machine learning. FIG. 4 is a flow chart showing the action of the device for seeking a workpiece holding form regarding calculation of the evaluation score. FIG. 5 is a diagram for describing how a workpiece is held with the robot hand. FIGS. 6A and 6B are diagrams for describing feature points set for the workpiece. FIG. 6A shows the workpiece WK, and FIG. 6B shows first to sixth six feature points SM1 to SM6 set for the workpiece WK shown in FIG. 6A. FIGS. 7A and 7B are diagrams for describing a method for calculating the evaluation score when there is no orientation change as one example. FIG. 7A shows six feature points SM1b to SM6b in the orientation before movement on the left side of the paper, and shows six feature points SM1a to SM6a in the orientation after movement on the right side of the paper. FIG. 7B shows each temporary evaluation score (temporary evaluation score) and each evaluation score in the first to sixth feature points SM1 to SM6, and the final evaluation score of the workpiece WK in the first holding form. FIGS. 8A and 8B are diagrams for describing the method for calculating the evaluation score when there is an orientation change as another example. FIG. 8A shows six feature points SM1b to SM6b in the orientation before movement on the left side of the paper, and shows six feature points SM1a to SM6a in the orientation after movement on the right side of the paper. FIG. 8B shows each temporary evaluation score (temporary evaluation score) and each evaluation score in the first to sixth feature points SM1 to SM6, and the final evaluation score of the workpiece WK in the second holding form.

When the power is turned on, the device for seeking a workpiece holding form D having the above-described configuration executes necessary initialization of each unit and starts an operation of the unit. In the device for seeking a workpiece holding form D, by executing the control processing program, the control processing unit 4 functionally includes the control unit 41, the workpiece recognition unit 42, the holding form generation unit 43, the robot control unit 44, the workpiece orientation recognition unit 45, the evaluation scoring unit 46, the machine learning unit 47, and the repetitive processing unit 48.

Note that for simplicity of description, here, the predetermined movement is a speed movement to move the robot hand 12 in one predetermined direction at a predetermined speed for a predetermined time, and is stored in the movement information storage unit 82 as the movement information. The range of the holding form generated by the holding form generation unit 43 in association with the predetermined movement (gripping range and gripping force range) may be set (restricted). The number of times the repetitive processing unit 48 repeats the processes is also stored in the storage unit 8.

To begin with, the workpiece WK is placed on the mounting table or the like in a predetermined mounted state. For example, the workpiece WK is placed by the user (operator) in the predetermined mounted state. Alternatively, for example, another robot is prepared, and the workpiece WK is placed by the other robot in the predetermined mounted state. Therefore, the second workpiece detection unit 3 and the workpiece recognition unit 42 can be omitted in the process for seeking a holding form of the workpiece WK and machine learning. Note that the predetermined mounted state is stored in the storage unit 8 in advance.

Subsequently, in FIG. 3, with the holding form generation unit 43 of the control processing unit 4, the device for seeking a workpiece holding form D executes the holding form generation process for generating the holding form to hold the workpiece WK with the robot hand 12 based on the mounted state of the workpiece WK (51). More specifically, the holding form generation unit 43 randomly generates the holding form of the workpiece WK (gripping position and gripping force) for the mounted state of the workpiece WK. In one example, the workpiece WK is a humanoid doll shown in FIG. 6A.

Next, with the robot control unit 44 of the control processing unit 4, the device for seeking a workpiece holding form D executes the gripping process for holding the workpiece WK with the robot hand 12 in the holding form generated by the holding form generation unit 43 in process S1 (S2). For example, as shown in FIG. 5, the workpiece WK of the doll is gripped by the robot hand 12 on a trunk of the doll.

Next, with the first workpiece detection unit 2, the device for seeking a workpiece holding form D detects the workpiece WK gripped in process S2 (S3). For example, the image of the workpiece WK is generated by the first workpiece detection unit 2 for the workpiece WK of the doll shown in FIG. 6A.

Next, with the workpiece orientation recognition unit 45 of the control processing unit 4, the device for seeking a workpiece holding form D determines whether the robot hand 12 is gripping the workpiece WK in process S2 (S4). More specifically, the workpiece orientation recognition unit 45 determines whether the robot hand 12 is gripping the workpiece WK based on the detection result of the workpiece WK before movement in process S3. In more detail, when the workpiece WK before movement is detected in process S3, in this example, when the workpiece WK (part or all of the workpiece WK) appears in the image of the workpiece WK, the workpiece orientation recognition unit 45 determines that the robot hand 12 is gripping the workpiece WK (Yes), and the device for seeking a workpiece holding form D then executes process S5. Meanwhile, when the workpiece WK before movement is not detected in process S3, in this example, when the workpiece WK does not appear in the image of the workpiece WK, the evaluation scoring unit 46 determines that the robot hand 12 is not gripping the workpiece WK (No), and the device for seeking a workpiece holding form D then executes process S9.

In the process S5, with the robot control unit 44 of the control processing unit 4, the device for seeking a workpiece holding form D executes the movement execution process to cause the robot hand 12 to execute the predetermined movement represented by the movement information stored in the movement information storage unit 82.

Next, with the first workpiece detection unit 2, the device for seeking a workpiece holding form D detects the workpiece WK after executing the predetermined movement in process S5, in a similar manner to process S3 (S6).

Next, with the workpiece orientation recognition unit 45, the device for seeking a workpiece holding form D determines whether the robot hand 12 is gripping the workpiece WK in a similar manner to process S4 (S7). As a result of this determination, when the robot hand 12 is gripping the workpiece WK (Yes), the device for seeking a workpiece holding form D then executes process S8. Meanwhile, as a result of the determination, when the robot hand 12 is not gripping the workpiece WK (No), the device for seeking a workpiece holding form D then executes process S9.

In the process S8, with the evaluation scoring unit 46 of the control processing unit 4, the device for seeking a workpiece holding form D determines the evaluation score EV when the grip is successful (final evaluation score EVr in the present embodiment), and then executes process S10.

More specifically, as shown in FIG. 4, to begin with, with the workpiece orientation recognition unit 45, the device for seeking a workpiece holding form D extracts the orientation before movement of the workpiece WK based on the detection result of the first workpiece detection unit 2 detected in process S3 (S21). More specifically, by extracting the edge from the image of the workpiece WK generated in process S3, the workpiece orientation recognition unit 45 detects the outline of the workpiece WK, extracts the plurality of feature points SM from the extracted outline of the workpiece WK, and recognizes the orientation of the workpiece WK by determining the position of each of the plurality of feature points SM.

For example, for the workpiece WK of the doll shown in FIG. 6A, as shown in FIG. 6B, left and right ends of the head are the first and second feature points SM1 and SM2, respectively, left and right fingers are the third and fourth feature points SM3 and SM4, respectively, and left and right toes are the fifth and sixth feature points SM5 and SM6, respectively. As shown on the left side of the paper of each of FIGS. 7A and 8A, the position of each of the first to sixth six feature points SM1b to SM6b is determined by the workpiece orientation recognition unit 45 from the image of the workpiece as the orientation before movement. Note that in FIGS. 7A and 7B, 8A and 8B, 10A and 10B, and 11A and 11B, a superscript b is further added to the feature point SM of the orientation before movement, and a superscript a is further added to the feature point SM of the orientation after movement.

Next, with the workpiece orientation recognition unit 45, the device for seeking a workpiece holding form D extracts the orientation after movement of the workpiece WK based on the detection result of the first workpiece detection unit 2 detected in process S5, in a similar manner to S21 (S22).

For example, as shown on the right side of the paper of each of FIGS. 7A and 8A, the position of each of the first to sixth six feature points SM1a to SM6a is determined by the workpiece orientation recognition unit 45 from the image of the workpiece WK as the orientation after movement. FIG. 7A shows the orientation before movement and the orientation after movement when the robot hand 12 holds the workpiece WK in the first holding form and executes the speed movement. FIG. 8A shows the orientation before movement and the orientation after movement when the robot hand 12 holds the workpiece WK in the second holding form different from the first holding form and executes the speed movement. The position of the feature point SM is represented, for example, by the pixel position. The first workpiece detection unit 2 generates the image of the workpiece WK at the same detection position (image capturing position) between when generating the image of the workpiece WK to detect the orientation before movement (when executing process S3) and when generating the image of the workpiece WK to detect the orientation after movement (when executing process S5).

Next, with the evaluation scoring unit 46, the device for seeking a workpiece holding form D determines the amount of discrepancy in the orientation after movement from the orientation before movement (S23). More specifically, for each of the plurality of feature points SM, the evaluation scoring unit 46 determines the amount of discrepancy between the position of the feature point SMb in the orientation before movement of the workpiece WK determined in process S21 and the position of the feature point SMa in the orientation after movement of the workpiece WK determined in process S22 corresponding to each other.

Next, with the evaluation scoring unit 46, the device for seeking a workpiece holding form D determines the evaluation score EV from the amount of discrepancy determined in process S23 (S24). More specifically, for each of the plurality of feature points SM, the evaluation scoring unit 46 determines the temporary evaluation score EVt of the feature point SM by converting the amount of discrepancy of the feature point SM into the evaluation score ev before weighting by using the score conversion information stored in the score conversion information storage unit 81, and determines the evaluation score EV at each of the plurality of feature points SM by multiplying the temporary evaluation score EVt of the feature point SM by the weight WT corresponding to the feature point SM.

Then, with the evaluation scoring unit 46, the device for seeking a workpiece holding form D determines the average of each evaluation score EV determined for each of the plurality of feature points SM as the final evaluation score EVr (S25), and finishes process S8.

For example, in the example shown in FIG. 7A, the first to sixth six feature points SM1 to SM6 each have no discrepancy between the orientation after movement and the orientation before movement. In the score conversion information shown in FIG. 2, as shown in FIG. 7B, each of the temporary evaluation scores (temporary evaluation scores) EVt1 to EVt6 respectively at the first to sixth feature points SM1 to SM6 is 100. In the examples shown in FIGS. 7B and 8B, each of the first and second weights WT1 and WT2 respectively at the first and second feature points SM1 and SM2 is set to 1.0, and each of the third to sixth weights WT3 to WT6 respectively at the third to sixth feature points SM3 to SM6 is set to 0.7. Therefore, each of the evaluation scores EV1 and EV2 respectively at the first and second feature points SM1 and SM2 is determined to be 100 (=100×1.0), and each of the evaluation scores EV3 to EV6 respectively at the third to sixth feature points SM3 to SM6 is determined to be 70 (=100×0.7). Therefore, the final evaluation score EVr in the first holding form is determined to be 80 (=(100+100+70+70+70+70)/6).

Meanwhile, in the example shown in FIG. 8A, each of the first to sixth six feature points SM1 to SM6 has a discrepancy between the orientation after movement and the orientation before movement. In the score conversion information shown in FIG. 2, as shown in FIG. 8B, each of the temporary evaluation scores (temporary evaluation scores) EVt1 and EVt2 respectively at the first and second feature points SM1 and SM2 is 70, the temporary evaluation score EVt3 at the third feature point SM3 is 40, the temporary evaluation score EVt4 at the fourth feature point SM4 is 70, the temporary evaluation score EVt5 at the fifth feature point SM5 is 40, and the temporary evaluation score EVt6 at the sixth feature point SM6 is zero. Each of the evaluation scores EV1 and EV2 respectively at the first and second feature points SM1 and SM2 is 70 (=70×1.0), the evaluation score EV3 at the third feature point SM3 is 28 (=40×0.7), the evaluation score EV4 at the fourth feature point SM4 is 49 (=70×0.7), the evaluation score EV5 at the fifth feature point SM5 is 28 (=40×0.7), and the evaluation score EV6 at the sixth feature point SM6 is 0 (=0×0.7). Therefore, the final evaluation score EVr in the second holding form is determined to be 40 (≈(70+70+28+49+28+0)/6).

When comparing the first holding form and the second holding form, the final evaluation score EVr;80 in the first holding form is higher (larger) than the final evaluation score EVr;40 in the second holding form. Therefore, the final evaluation score EVr;80 in the first holding form and the final evaluation score EVr;40 in the second holding form are output from the output unit 6, and by referring to the scores, the user can determine that the first holding form is a holding form that can reduce the orientation change of the workpiece after gripping more than the second holding form.

Since the device for seeking a workpiece holding form D determines the final evaluation score EVr for various holding forms as will be described later, the final evaluation score EVr for each of the various holding forms is output from the output unit 6, and by referring to the score, the user can find the holding form that can reduce the orientation change of the workpiece after gripping.

Returning to FIG. 3, in the process S9, with the evaluation scoring unit 46, the device for seeking a workpiece holding form D determines the evaluation score when gripping fails, as in process S8, and then executes process S10. In the example shown in FIGS. 2, 6A and 6B, by setting each of the temporary evaluation scores EVt1 to EVt6 respectively at the first to sixth feature points SM1 to SM6 to −50, and multiplying the temporary evaluation scores EVt1 to EVt6 by the weights WT1 to WT6 of the first to sixth feature points SM1 to SM6, respectively, the evaluation scoring unit 46 determines the evaluation scores EV1 to EV6 at the first to sixth feature points SM1 to SM6, respectively, and determines the final evaluation score EVr;−40 (=(−50−50−35−35−35−35)/6) in the holding form in case of failure by determining the average thereof.

In the process S10, with the machine learning unit 47 of the control processing unit 4, the device for seeking a workpiece holding form D executes machine learning by reinforcement learning of Q-learning, based on the holding form generated by the holding form generation unit 43 in process S1, the predetermined movement, and the evaluation score EV determined by the evaluation scoring unit 46 in process S8 or process S9 (final evaluation score EVr in the present embodiment). More specifically, the machine learning unit 47 executes machine learning by assigning the predetermined movement to the state s of Formula 1 of Q-learning, assigning the holding form to the action a, and assigning the final evaluation score EVr to the reward R.

Next, with the repetitive processing unit 48 of the control processing unit 4, the device for seeking a workpiece holding form D determines whether execution of the predetermined number of times has finished (S11). As a result of this determination, when the execution of the predetermined number of times has not finished (No), to repeat the holding form generation process, the gripping process, the movement execution process, and the evaluation scoring process, the repetitive processing unit 48 returns the process to process S1. As a result of the determination, when the execution of the predetermined number of times has finished (Yes), the repetitive processing unit 48 finishes this process.

By each of such processes, various holding forms are evaluated and machine learning is executed for one speed movement. As described above, since the device for seeking a workpiece holding form D is configured to output the final evaluation score EVr in each of the various holding forms to the output unit 6, the user can find the holding form that can reduce the orientation change of the workpiece after gripping by referring to the final evaluation score EVr in each of the various holding forms.

Then, in fact, as needed, for various plurality of speed movements to move in various plurality of directions at various plurality of speeds for various plurality of times, the device for seeking a workpiece holding form D evaluates various holding forms and executes machine learning. Similarly, as needed, for various plurality of acceleration movements to move in various plurality of directions at various plurality of accelerations for various plurality of times, the device for seeking a workpiece holding form D evaluates various holding forms and executes machine learning. Similarly, as needed, for various plurality of rotational movements to rotate in various plurality of angular ranges at various plurality of speeds (or plurality of angular speeds) or various plurality of accelerations (or plurality of angular accelerations) for various plurality of times, the device for seeking a workpiece holding form D evaluates various holding forms and executes machine learning. Similarly, as needed, for various plurality of vibration movements to vibrate in various plurality of amplitude at various plurality of frequencies for various plurality of times, the device for seeking a workpiece holding form D evaluates various holding forms and executes machine learning.

In the operation after machine learning, when the movement (action) of the robot 1 is set and the workpiece WK is placed on the mounting table or the like, the mounted state of the workpiece WK is recognized by the second workpiece detection unit 3 and the workpiece recognition unit 42, the holding form for the mounted state of the workpiece WK and the set movement of the robot 1 is determined by the machine learning model, the robot hand 12 is controlled to hold the workpiece in the determined holding form, and the set movement of the robot 1 is executed.

As described above, the device for seeking a workpiece holding form D in the embodiment and the method for seeking a workpiece holding form implemented therein can determine the plurality of evaluation scores EV for various plurality of holding forms for the mounted state of the workpiece WK, the final evaluation score EVr in the present embodiment by executing a predetermined number of times the holding form generation process, the gripping process, the movement execution process, and the evaluation scoring process. Therefore, by comparing each evaluation score EVr, the user can find the holding form that can reduce the orientation change of the workpiece WK after gripping for the mounted state of the workpiece WK when holding the workpiece WK with the robot hand 12.

Since the device for seeking a workpiece holding form D and the method for seeking a workpiece holding form include the machine learning unit 47 and executes machine learning on the machine learning unit 47, when holding the workpiece WK with the robot hand 12 for the mounted state of the workpiece WK, the holding form that can reduce the orientation change of the workpiece WK after gripping can be output from the machine learning unit 47 after machine learning.

The device for seeking a workpiece holding form D and the method for seeking a workpiece holding form can determine the evaluation score by the amount of orientation change between the orientation after movement and the orientation before movement.

The device for seeking a workpiece holding form D and the method for seeking a workpiece holding form set the weight WT for each of the plurality of feature points SM set for the workpiece WK, and determine each evaluation score EV by using the weight WT for each of the plurality of feature points SM. Therefore, by making the weight WT for the feature point SM that is difficult to allow the orientation change larger than the weight WT for the feature point SM that is easy to allow the orientation change, the holding form that can reduce the orientation change of the workpiece WK after gripping while taking into account permissiveness of the orientation change can be found.

The device for seeking a workpiece holding form D and the method for seeking a workpiece holding form can determine the overall evaluation score for the plurality of feature points SM by determining the final evaluation score EVr.

Note that in the embodiment, by referring to and comparing each final evaluation score EVr in various holding forms, the user finds the holding form that can reduce the orientation change of the workpiece after gripping. However, a configuration may be used to seek the holding form that can reduce the orientation change of the workpiece after the device for seeking a workpiece holding form D grips the workpiece. In this case, the device for seeking a workpiece holding form D further functionally includes a holding form seeking unit in the control processing unit 4. The holding form seeking unit compares the plurality of evaluation scores in the plurality of holding forms determined by execution of the predetermined number of times, compares the plurality of final evaluation scores EVr in the above description, and seeks the holding form that is the highest evaluation score (highest final evaluation score EVr) among the plurality of holding forms.

In the embodiment, the amount of discrepancy in the orientation after movement from the orientation before movement is determined for the whole workpiece WK and the evaluation score is determined. However, the amount of discrepancy between the orientation after movement and the orientation before movement may be determined for part of the workpiece WK and the evaluation score may be determined. In such a device for seeking a workpiece holding form D, the target area to determine the evaluation score is input into the input unit 5, and the evaluation scoring unit 46 determines the evaluation score in the target area input from the input unit 5. That is, the evaluation scoring unit 46 determines the evaluation score based on the amount of discrepancy between the orientation before movement and the orientation after movement in the feature points within the target area input from the input unit 5. With this operation, the orientation change of the workpiece WK can be evaluated by focusing on part of the workpiece WK, and the orientation change in other parts of the workpiece WK except for the above-described part can be disregarded.

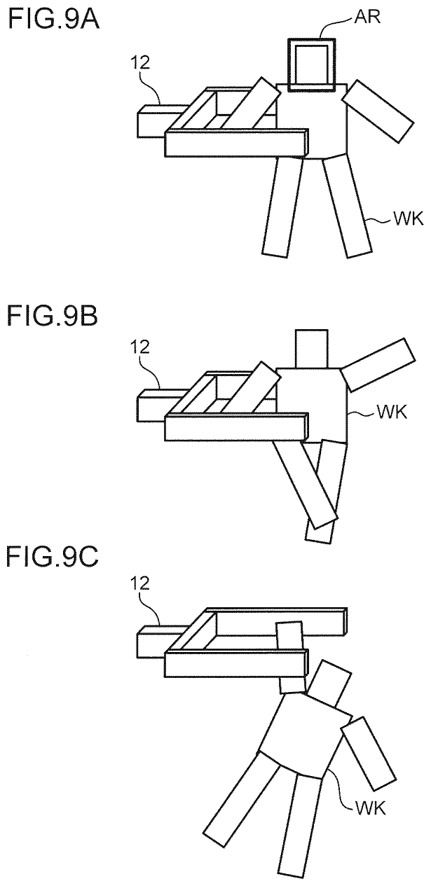

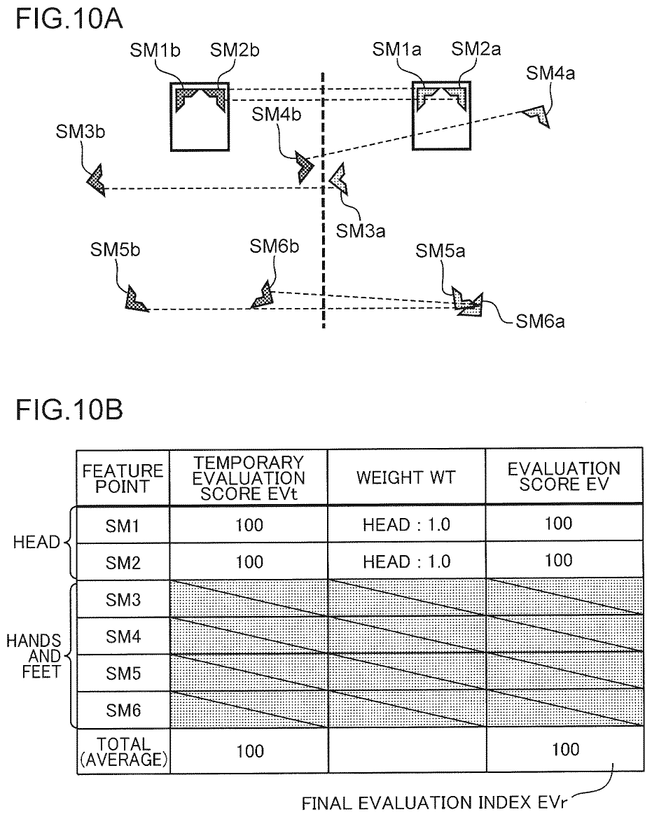

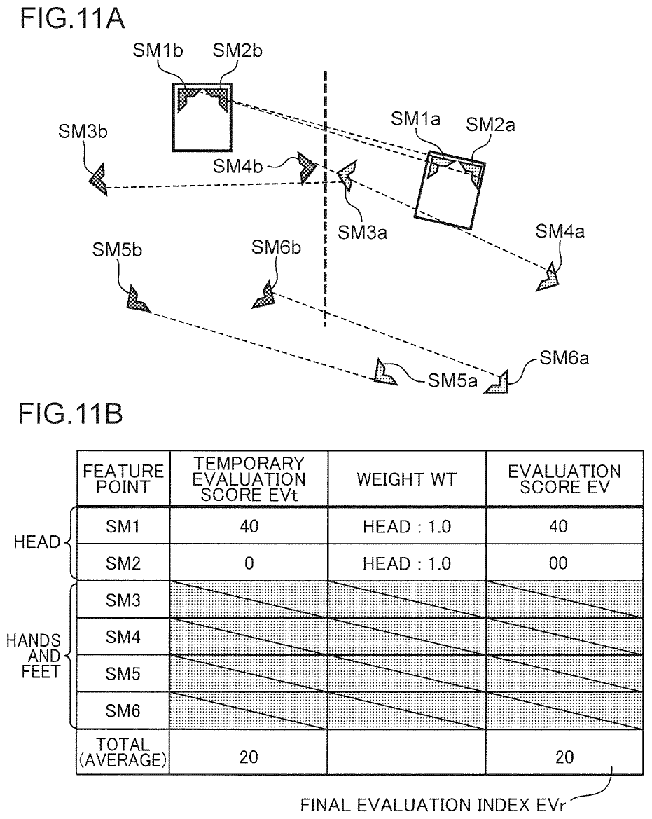

FIGS. 9A to 9C are diagrams for describing a variation to restrict a portion of the workpiece for determining the evaluation score. FIG. 9A is a diagram for describing the restricted portion and shows the orientation before movement of the workpiece WK. FIG. 9B shows the orientation after movement of the workpiece WK when there is no orientation change in the restricted portion with respect to the orientation before movement shown in FIG. 9A. FIG. 9C shows the orientation after movement of the workpiece WK when there is no orientation change in the restricted portion with respect to the orientation before movement shown in FIG. 9A. FIGS. 10A and 10B are diagrams for describing the method for calculating the evaluation score when there is no orientation change in the restricted portion as one example. FIG. 10A shows six feature points SM1b to SM6b in the orientation before movement shown in FIG. 9A on the left side of the paper, and shows six feature points SM1a to SM6a in the orientation after movement shown in FIG. 9B on the right side of the paper. FIG. 10B shows the temporary evaluation score (temporary evaluation score) and the evaluation score in each of the first to sixth feature points SM1 to SM6, and the final evaluation score of the workpiece WK in the third holding form. FIGS. 11A and 11B are diagrams for describing the method for calculating the evaluation score when there is an orientation change in the restricted portion as another example. FIG. 11A shows six feature points SM1b to SM6b in the orientation before movement shown in FIG. 9A on the left side of the paper, and shows six feature points SM1a to SM6a in the orientation after movement shown in FIG. 9C on the right side of the paper. FIG. 11B shows the temporary evaluation score (temporary evaluation score) and the evaluation score in each of the first to sixth feature points SM1 to SM6, and the final evaluation score of the workpiece WK in the fourth holding form different from the third holding form.

For example, when the first workpiece detection unit 2 is an image capturing device, after the execution of the process S3 and before the execution of the process S4, the device for seeking a workpiece holding form D outputs the image of the workpiece WK generated by the image capturing device as the first workpiece detection unit 2 to the output unit 6 with the control processing unit 4. As shown in FIG. 9A, the user refers to the image of the workpiece WK and inputs the target area AR in the workpiece WK from the input unit 5. The device for seeking a workpiece holding form D receives and acquires the input of the target area AR in the workpiece WK with the control processing unit 4. In the example shown in FIG. 9A, the head of the workpiece WK is input as the target area AR, and the first and second feature points SM1 and SM2 corresponding to the input target area AR out of the first to sixth feature points SM1 to SM6 of the workpiece WK are designated.

Then, in process S8, to begin with, each of process S21 and process S22 are executed as described above. For example, for the workpiece WK shown in FIG. 9A, in process S21, as shown on the left side of the paper of each of FIGS. 10A and 11A, the position of each of the first to sixth six feature points SM1b to SM6b is determined by the workpiece orientation recognition unit 45 from the image of the workpiece WK as the orientation after movement. In process S22, for the workpiece WK shown in FIG. 9B, as shown on the right side of the paper in FIG. 10A, the position of each of the first to sixth six feature points SM1a to SM6a is determined by the workpiece orientation recognition unit 45 from the image of the workpiece WK as the orientation after movement. For the workpiece WK shown in FIG. 9C, as shown on the right side of the paper in FIG. 11A, the position of each of the first to sixth six feature points SM1a to SM6a is determined by the workpiece orientation recognition unit 45 from the image of the workpiece WK as the orientation before movement.

Note that in the above description, the position of each of all the feature points SM in the workpiece WK is determined in each of process S21 and process S22, but only the position of each of the first and second feature points SM1 and SM2 corresponding to the target area AR may be determined.

In process S23 of process S8, with the evaluation scoring unit 46, the device for seeking a workpiece holding form D determines the amount of discrepancy between the orientation after movement and the orientation before movement of the workpiece WK in the target area AR. More specifically, for each of the plurality of feature points SM corresponding to the target area AR, the evaluation scoring unit 46 determines the amount of discrepancy between the position of the feature point SMb in the orientation before movement of the workpiece WK determined in process S21 and the position of the feature point SMa in the orientation after movement of the workpiece WK determined in process S22 corresponding to each other.

Next, in process S24 of process S8, with the evaluation scoring unit 46, the device for seeking a workpiece holding form D determines the evaluation score EV from the amount of discrepancy determined in process S23. More specifically, for each of the plurality of feature points SM corresponding to the target area AR, the evaluation scoring unit 46 determines the temporary evaluation score EVt of the feature point SM by converting the amount of discrepancy of the feature point SM into the evaluation score ev before weighting by using the score conversion information stored in the score conversion information storage unit 81, and determines the evaluation score EV in each of the plurality of feature points SM corresponding to the target area AR by multiplying the temporary evaluation score EVt at the feature point SM by the weight WT corresponding to the feature point SM.

In process S25 of process S8, with the evaluation scoring unit 46, the device for seeking a workpiece holding form D determines the average of each evaluation score EV determined for each of the plurality of feature points SM corresponding to the target area AR as the final evaluation score EVr.

For example, in the example shown in FIG. 10A, the first and second two feature points SM1 and SM2 corresponding to the target area AR shown in FIGS. 9A and 9B have no discrepancy between the orientation after movement and the orientation before movement. In the score conversion information shown in FIG. 2, as shown in FIG. 10B, each of the temporary evaluation scores (temporary evaluation scores) EVt1 and EVt2 respectively at the first and second feature points SM1 and SM2 is 100. Each of the evaluation scores EV1 and EV2 respectively at the first and second feature points SM1 and SM2 multiplied by the first and second weights WT1 and WT2 of the first and second feature points SM1 and SM2 is determined to be 100 (=100×1.0), and the final evaluation score EVr in the third holding form is determined to be 100 (=(100+100)/2).

Meanwhile, in the example shown in FIG. 11A, each of the first and second two feature points SM1 and SM2 corresponding to the target area AR shown in FIGS. 9A and 9B has a discrepancy between the orientation after movement and the orientation before movement. In the score conversion information shown in FIG. 2, as shown in FIG. 11B, the temporary evaluation scores (temporary evaluation scores) EVt1 and EVt2 at the first and second feature points SM1 and SM2 are 40 and 0, respectively. The evaluation scores EV1 and EV2 at the first and second feature points SM1 and SM2 multiplied by the first and second weights WT1 and WT2 of the first and second feature points SM1 and SM2 are determined to be 40 (=40×1.0) and 0 (=0×1.0), respectively. The final evaluation score EVr in the fourth holding form is determined to be 20 (=(40+0)/2).

When comparing the third holding form and the fourth holding form, the final evaluation score EVr;100 in the third holding form is higher (larger) than the final evaluation score EVr;20 in the fourth holding form. Therefore, the final evaluation score EVr;100 in the third holding form and the final evaluation score EVr;20 in the fourth holding form are output from the output unit 6, and by referring to the scores, the user can determine that the third holding form is a holding form that can reduce the orientation change of the workpiece after gripping more than the fourth holding form.

In the embodiment, the amount of discrepancy between the orientation before movement and the orientation after movement has been determined from the amount of discrepancy in the position of the feature point SM of the workpiece WK, but this method is not restrictive. For example, the amount of discrepancy may be determined by detecting the workpiece WK as point group data with a LiDAR or the like and by matching the point group representing the workpiece WK in the orientation before movement with the point group representing the workpiece WK in the orientation after movement to determine coincidence ((amount of discrepancy)=(coincidence)). In this case, the coincidence is associated with the evaluation score ev before weighting, and the coincidence is converted into the evaluation score ev before weighting.

In the embodiment, the movement information has been set as appropriate in advance and stored in the movement information storage unit 82, but the device for seeking a workpiece holding form D may be configured to allow user input. In such a device for seeking a workpiece holding form D, the predetermined movement is input into the input unit 5, and the input predetermined movement is stored in the movement information storage unit 82 as the movement information. When each of the processes shown in FIGS. 3 and 4 is executed, the predetermined movement input from the input unit 5 is executed by the robot control unit 44, which is one example of a movement execution unit.

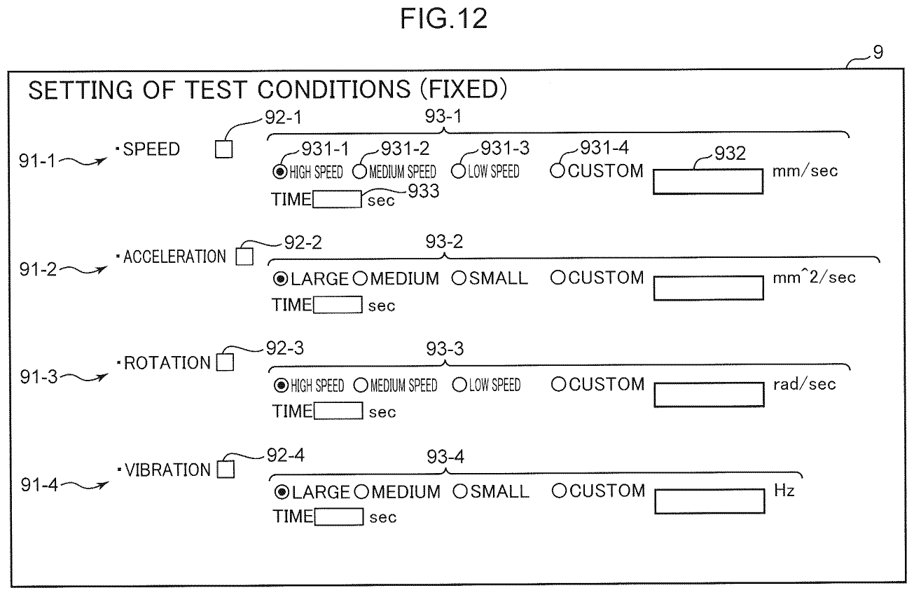

FIG. 12 is a diagram for describing a movement input screen in another variation to input and setting the predetermined movement to be executed after holding the workpiece with the robot hand.

When inputting the predetermined movement from the input unit 5, for example, the movement input screen 9 shown in FIG. 12 is displayed on the output unit 6, and the user uses the movement input screen 9 to input the predetermined movement from the input unit 5.

This movement input screen 9 is provided with an input area for each type of movement, and includes a first input area 91-1 for inputting the speed movement, a second input area 91-2 for inputting the acceleration movement, a third input area 91-3 for inputting the rotational movement, and a fourth input area 91-4 for inputting the vibration movement. The first input area 91-1 includes a first check box 92-1 to set whether to input the speed movement and a first content setting area 93-1 for inputting content of the speed movement. The first content setting area 93-1 includes four radio buttons 931-1 to 931-4 for setting the speed to the fast speed, medium speed, slow speed, and custom, respectively, a speed input field 932 for inputting a numerical value when the speed is set to custom, and a time input field 933 for inputting the time of the speed movement. A default value is set for each of high speed, medium speed, and low speed as appropriate. When inputting the speed movement as the predetermined movement, the user checks the first check box 92-1 by using the input unit 5, and when setting the speed to the medium speed, the user selects the radio button 931-2 for the medium speed by using the input unit 5, and inputs a numerical value into the time input field 933 by using the input unit 5. With this operation, the speed movement is input as the predetermined movement, and the content is input and stored in the movement information storage unit 82 as the movement information. Similarly, the second input area 91-2 includes a second check box 92-2 to set whether to input the acceleration movement and a second content setting area 93-2 for inputting the content of the acceleration movement. The third input area 91-3 includes a third check box 92-3 to set whether to input the rotational movement and a third content setting area 93-3 for inputting the content of the rotational movement. The fourth input area 91-4 includes a fourth check box 92-4 to set whether to input the vibration movement and a fourth content setting area 93-4 for inputting the content of the vibration movement.

In the embodiment, the machine learning unit 47 after machine learning may execute machine learning by using the result obtained from the operation of the robot 1.

For example, in the device for seeking a workpiece holding form D, during the operation after machine learning, the machine learning unit 47 may also execute machine learning at a learning rate lower than a learning rate during machine learning. In this case, to detect the orientation before movement before the action of operation, the workpiece WK is detected by the first workpiece detection unit 2, and to detect the orientation after movement after the action of operation, the workpiece WK is detected by the first workpiece detection unit 2. Such a device for seeking a workpiece holding form D can reflect the result during operation on the machine learning unit 47, and can reduce the impact on the machine learning unit 47 by reducing the learning rate even when a relatively unfavorable holding form is executed, and therefore degradation of reduction of the orientation change of the workpiece after the gripping can be suppressed.

For example, in the device for seeking a workpiece holding form D, during the operation after machine learning, instead of the holding form generation unit 43, the machine learning unit 47 generates the holding form based on the mounted state of the workpiece WK. During the operation after machine learning, every time the robot hand 12 holds the workpiece WK, the result information storage unit 83 stores, in association with each other, as result information, the holding form generated by the machine learning unit 47, the movement (action) in the operation, and the evaluation score EV determined by the evaluation scoring unit 46 (final evaluation score EVr in the above description). At predetermined timing set in advance after the machine learning (for example, every week, every month, or the like), machine learning is executed again by using the holding form generated by the machine learning unit 47 and stored in the result information storage unit 83 in association with each other, the movement (action) in the operation, and the evaluation score EV determined by the evaluation scoring unit 46 (final evaluation score EVr in the above description). In this case as well, to detect the orientation before movement before the action of operation, the workpiece WK is detected by the first workpiece detection unit 2, and to detect the orientation after movement after the action of operation, the workpiece WK is detected by the first workpiece detection unit 2. Such a device for seeking a workpiece holding form D can execute machine learning collectively on the result by the operation. In particular, a relatively unfavorable holding form can be excluded from the result, and machine learning can be executed with the result excluding the relatively unfavorable holding form.

In the embodiment, the predetermined movement may be, for example, a combination of the plurality of movements with different contents in one type of movement, or may be, for example, a plurality of combinations of the speed movement, the acceleration movement, the rotational movement, and the vibration movement, or may be, for example, a combination of these described above.

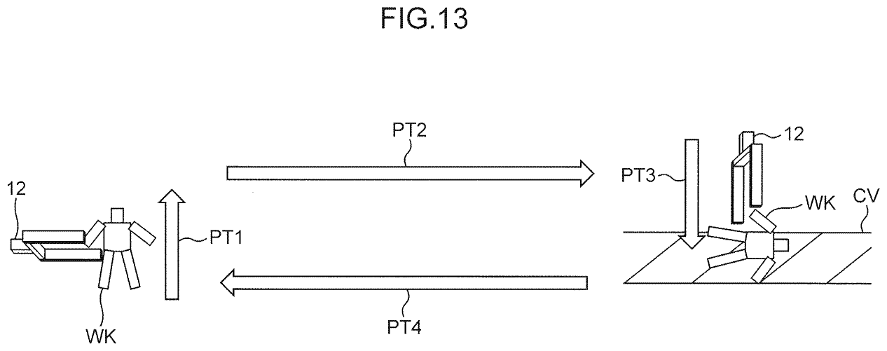

FIG. 13 is a diagram for describing another variation to find a holding form in a series of robot actions. For example, as shown in FIG. 13, the predetermined movement includes a first movement PT1 to rise at a first speed for a first time after gripping the workpiece WK in the holding form generated by the holding form generation unit 43 (gripping position, gripping force), a second movement PT2 to move from the mounting place of the workpiece WK to a conveyor CV at a first acceleration for a second time, a third movement PT3 to descend at a second speed for a third time, and a fourth movement PT4 to move from the conveyor CV to the mounting place of the workpiece WK at a second acceleration for a fourth time. By setting the predetermined movement in this way, it is possible to evaluate the holding form of the workpiece WK in transfer between processes.

This specification discloses various aspects of the technology as described above, and the main technology thereof is summarized below.

A device for seeking a holding form for a robot hand according to one aspect is a device that can find a holding form suitable for a mounted state of a placed workpiece when holding the workpiece with the robot hand, and includes: a holding form generation unit that executes a holding form generation process to generate the holding form to hold the workpiece with the robot hand based on the mounted state of the workpiece; a hand control unit that executes a gripping process to hold the workpiece with the robot hand in the holding form generated by the holding form generation unit; a movement execution unit that executes a movement execution process to cause the robot hand to execute a predetermined movement after holding the workpiece with the robot hand; an evaluation scoring unit that executes an evaluation scoring process to determine an evaluation score to evaluate the holding form after the movement execution unit causes the robot hand to execute the predetermined movement; and a repetitive processing unit that causes the holding form generation unit, the hand control unit, the movement execution unit, and the evaluation scoring unit to execute a predetermined number of times the holding form generation process, the gripping process, the movement execution process, and the evaluation scoring process, respectively. The holding form generation unit generates different holding forms in the execution of the predetermined number of times. Preferably, in the device for seeking a holding form for a robot hand, the holding form is represented (defined) by a gripping position and gripping force to grip the workpiece with the robot hand. Preferably, in the device for seeking a holding form for a robot hand, the predetermined movement includes at least one of a speed movement to move the robot hand in one predetermined direction at a predetermined speed for a predetermined time, an acceleration movement to move the robot hand in one predetermined direction at predetermined acceleration for a predetermined time, a rotational movement to rotate the robot hand in a predetermined angular range at a predetermined speed (or predetermined angular speed) or predetermined acceleration (or predetermined angular acceleration) for a predetermined time, and a vibration movement to vibrate the robot hand in a predetermined amplitude range at a predetermined frequency (or cycle) for a predetermined time.

Such a device for seeking a holding form for a robot hand can determine the plurality of evaluation scores for various plurality of holding forms for the mounted state of the workpiece, by executing a predetermined number of times the holding form generation process, the gripping process, the movement execution process, and the evaluation scoring process. Therefore, by comparing each evaluation score, it is possible to find the holding form that can reduce the orientation change of the workpiece after gripping for the mounted state of the workpiece when holding the workpiece with the robot hand.

In another aspect, the device for seeking a holding form for a robot hand further includes a machine learning unit that executes machine learning on the holding form based on the holding form generated by the holding form generation unit, the predetermined movement, and the evaluation score determined by the evaluation scoring unit, in which the repetitive processing unit further causes the machine learning unit to execute the machine learning in the execution of the predetermined number of times. Preferably, in the device for seeking a holding form for a robot hand, the machine learning is reinforcement learning. Preferably, the reinforcement learning is Q-learning.

Since such a device for seeking a workpiece holding form for a robot hand includes the machine learning unit and executes machine learning on the machine learning unit, when holding the workpiece with the robot hand, for the mounted state of the workpiece, the holding form that can reduce the orientation change of the workpiece after gripping can be output from the machine learning unit after machine learning.

In another aspect, the device for seeking a holding form for a robot hand further includes an orientation detection unit that detects an orientation of the workpiece held by the robot hand, in which the evaluation scoring unit determines the evaluation score based on an orientation before movement that is the orientation of the workpiece detected by the orientation detection unit before executing the predetermined movement, and an orientation after movement that is the orientation of the workpiece detected by the orientation detection unit after the predetermined movement is executed.

Such a device for seeking a workpiece holding form for a robot hand can determine the evaluation score by the amount of orientation change between the orientation after movement and the orientation before movement.

In another aspect, the device for seeking a holding form for a robot hand further includes an input unit that inputs the predetermined movement, in which the movement execution unit executes the predetermined movement input by the input unit.

Since such a device for seeking a workpiece holding form for a robot hand further includes the input unit, the user can set the predetermined movement. In particular, the user can set the predetermined movement in consideration of the situation in which the robot hand is operated.

In another aspect, in the device for seeking a holding form for a robot hand, a plurality of feature points for determining the evaluation score is set for the workpiece, a weight when determining the evaluation score is set for each of the plurality of feature points, and the evaluation scoring unit uses the weight for each of the plurality of feature points to determine the evaluation score.

Such a device for seeking a workpiece holding form for a robot hand sets the weight for each of the plurality of feature points set for the workpiece, and determines each evaluation score by using the weight for each of the plurality of feature points. Therefore, by making the weight of the feature point that is difficult to allow the orientation change larger than the weight of the feature point that is easy to allow the orientation change, the holding form that can reduce the orientation change of the workpiece after gripping while taking into account permissiveness of the orientation change can be found.

In another aspect, in the device for seeking a holding form for a robot hand, the evaluation scoring unit further determines an average of the evaluation score determined for each of the plurality of feature points as a final evaluation score.

Such a device for seeking a workpiece holding form for a robot hand can determine overall evaluation scores for the plurality of feature points.

In another aspect, in the device for seeking a holding form for a robot hand, the machine learning is reinforcement learning of Q-learning, and even during an operation after the machine learning, the machine learning unit executes the machine learning at a learning rate lower than a learning rate during the machine learning.

Such a device for seeking a workpiece holding form for a robot hand can reflect the result during the operation on the machine learning unit, and can reduce the impact on the machine learning unit by reducing the learning rate even when a relatively unfavorable holding form is executed, and therefore degradation of reduction of the orientation change of the workpiece after the gripping can be suppressed.

In another aspect, in the device for seeking a holding form for a robot hand, during an operation after the machine learning, instead of the holding form generation unit, the machine learning unit generates the holding form based on the mounted state of the workpiece, the device further includes a result information storage unit that stores the holding form generated by the machine learning unit, the movement in the operation, and the evaluation score determined by the evaluation scoring unit in association with each other during the operation after the machine learning, every time holding the workpiece with the robot hand, and the machine learning unit executes the machine learning again at predetermined timing after the machine learning by using the holding form generated by the machine learning unit and stored in the result information storage unit in association with each other, the movement in the operation, and the evaluation score determined by the evaluation scoring unit.

Such a device for seeking a workpiece holding form for a robot hand can execute machine learning collectively on the result by the operation. In particular, a relatively unfavorable holding form can be excluded from the result, and machine learning can be executed with the result excluding the relatively unfavorable holding form.

A method for seeking a holding form for a robot hand according to one aspect is a method for finding a holding form suitable for a mounted state of a placed workpiece when holding the workpiece with the robot hand. The method includes: a holding form generation step of generating the holding form to hold the workpiece with the robot hand based on the mounted state of the workpiece; a hand control step of holding the workpiece with the robot hand in the holding form generated in the holding form generation step; a movement execution step of causing the robot hand to execute a predetermined movement after holding the workpiece with the robot hand; and an evaluation scoring step of determining an evaluation score to evaluate the holding form after causing the robot hand to execute the predetermined movement in the movement execution step. The holding form generation step, the hand control step, the movement execution step, and the evaluation scoring step are executed a predetermined number of times, and the holding form generation step includes generating different holding forms in the execution the predetermined number of times.

Such a method for seeking a holding form for a robot hand can determine the plurality of evaluation scores for various plurality of holding forms for the mounted state of the workpiece by executing a predetermined number of times the holding form generation step, the hand control step, the movement execution step, and the evaluation scoring step. Therefore, by comparing each evaluation score, the user can find the holding form that can reduce the orientation change of the workpiece after gripping for the mounted state of the workpiece when holding the workpiece with the robot hand.

In order to describe the present disclosure, the present disclosure has been appropriately and fully described above by means of the embodiment with reference to the drawings, but it should be appreciated that one skilled in the art should be able to modify and/or improve the embodiment described above easily. Therefore, as long as the modification or improvement implemented by one skilled in the art does not depart from the scope of the claims, it is understood that the modification or improvement is included in the scope of the claims.

The present disclosure makes it possible to provide a device for seeking a workpiece holding form for a robot hand and a method for seeking a workpiece holding form that can find a more suitable holding form when holding the workpiece with the robot hand.

1. A device for seeking a workpiece holding form for a robot hand for finding a holding form suitable for a mounted state of the placed workpiece when holding the workpiece with the robot hand, the device comprising:
processing circuitry configured to
execute a holding form generation process to generate the holding form to hold the workpiece with the robot hand based on the mounted state of the workpiece;
execute a gripping process to hold the workpiece with the robot hand in the holding form generated by the holding form generation process;
execute a movement execution process to cause the robot hand to execute a predetermined movement after holding the workpiece with the robot hand;
execute an evaluation scoring process to determine an evaluation score to evaluate the holding form after the movement execution process causes the robot hand to execute the predetermined movement; and
cause the holding form generation process, the gripping process, the movement execution process, and the evaluation scoring process to execute a predetermined number of times,
wherein the holding form generation process generates different holding forms in the execution of the predetermined number of times.

2. The device for seeking a workpiece holding form for a robot hand according to claim 1, wherein
the processing circuitry is further configured to
execute a machine learning process that executes machine learning on the holding form based on the holding form generated by the holding form generation process, the predetermined movement, and the evaluation score determined by the evaluation scoring process, and
cause the machine learning process to execute the machine learning in the execution of the predetermined number of times.

3. The device for seeking a workpiece holding form for a robot hand according to claim 1, wherein
the processing circuitry is further configured to
execute an orientation detection process that detects an orientation of the workpiece held by the robot hand, and
wherein the evaluation scoring process determines the evaluation score based on an orientation before movement that is the orientation of the workpiece detected by the orientation detection process before executing the predetermined movement and an orientation after movement that is the orientation of the workpiece detected by the orientation detection process after the predetermined movement is executed.

4. The device for seeking a workpiece holding form for a robot hand according to claim 1, further comprising:
an input unit configured to input the predetermined movement,
wherein the movement execution process executes the predetermined movement input by the input unit.

5. The device for seeking a workpiece holding form for a robot hand according to claim 1, wherein
a plurality of feature points for determining the evaluation score is set for the workpiece,
a weight when determining the evaluation score is set for each of the plurality of feature points, and
the evaluation scoring process uses the weight for each of the plurality of feature points to determine the evaluation score.

6. The device for seeking a workpiece holding form for a robot hand according to claim 5, wherein
the evaluation scoring process further determines an average of the evaluation score determined for each of the plurality of feature points as a final evaluation score.

7. The device for seeking a workpiece holding form for a robot hand according to claim 2, wherein
the machine learning is reinforcement learning of Q-learning, and
even during an operation after the machine learning, the machine learning process executes the machine learning at a learning rate lower than a learning rate during the machine learning.

8. The device for seeking a workpiece holding form for a robot hand according to claim 2, wherein
during an operation after the machine learning, instead of the holding form generation process, the machine learning process generates the holding form based on the mounted state of the workpiece,
the device further comprises a result information storage unit configured to store the holding form generated by the machine learning process, the movement in the operation, and the evaluation score determined by the evaluation scoring process in association with each other during the operation after the machine learning, every time holding the workpiece with the robot hand, and
the machine learning process executes the machine learning again at predetermined timing after the machine learning by using the holding form generated by the machine learning process and stored in the result information storage unit in association with each other, the movement in the operation, and the evaluation score determined by the evaluation scoring process.

9. A method for seeking a workpiece holding form for a robot hand for finding a holding form suitable for a mounted state of the placed workpiece when holding the workpiece with the robot hand, the method comprising:
generating, by a processor, the holding form to hold the workpiece with the robot hand based on the mounted state of the workpiece;
holding the workpiece with the robot hand in the holding form generated in the holding form generating;
a movement execution process of causing the robot hand to execute a predetermined movement after holding the workpiece with the robot hand; and
determining, by the processor, an evaluation score to evaluate the holding form after causing the robot hand to execute the predetermined movement in the movement execution process,
wherein the holding form generating, the holding, the movement execution process, and the determining of the evaluation scoring are executed a predetermined number of times, and
the holding form generating includes generating different holding forms in the execution of the predetermined number of times.

10. The device for seeking a workpiece holding form for a robot hand according to claim 2, wherein
the processing circuitry is further configured to
execute an orientation detection process that detects an orientation of the workpiece held by the robot hand, and
wherein the evaluation scoring process determines the evaluation score based on an orientation before movement that is the orientation of the workpiece detected by the orientation detection process before executing the predetermined movement and an orientation after movement that is the orientation of the workpiece detected by the orientation detection process after the predetermined movement is executed.

11. The device for seeking a workpiece holding form for a robot hand according to claim 2, further comprising:
an input unit configured to input the predetermined movement,
wherein the movement execution process executes the predetermined movement input by the input unit.

12. The device for seeking a workpiece holding form for a robot hand according to claim 3, further comprising:
an input unit configured to input the predetermined movement,
wherein the movement execution process executes the predetermined movement input by the input unit.

13. The device for seeking a workpiece holding form for a robot hand according to claim 2, wherein
a plurality of feature points for determining the evaluation score is set for the workpiece,
a weight when determining the evaluation score is set for each of the plurality of feature points, and
the evaluation scoring process uses the weight for each of the plurality of feature points to determine the evaluation score.

14. The device for seeking a workpiece holding form for a robot hand according to claim 3, wherein
a plurality of feature points for determining the evaluation score is set for the workpiece,
a weight when determining the evaluation score is set for each of the plurality of feature points, and
the evaluation scoring process uses the weight for each of the plurality of feature points to determine the evaluation score.

15. The device for seeking a workpiece holding form for a robot hand according to claim 4, wherein
a plurality of feature points for determining the evaluation score is set for the workpiece,
a weight when determining the evaluation score is set for each of the plurality of feature points, and
the evaluation scoring process uses the weight for each of the plurality of feature points to determine the evaluation score.

16. The device for seeking a workpiece holding form for a robot hand according to claim 3, wherein
the machine learning is reinforcement learning of Q-learning, and
even during an operation after the machine learning, the machine learning process executes the machine learning at a learning rate lower than a learning rate during the machine learning.

17. The device for seeking a workpiece holding form for a robot hand according to claim 4, wherein
the machine learning is reinforcement learning of Q-learning, and
even during an operation after the machine learning, the machine learning process executes the machine learning at a learning rate lower than a learning rate during the machine learning.

18. The device for seeking a workpiece holding form for a robot hand according to claim 5, wherein
the machine learning is reinforcement learning of Q-learning, and
even during an operation after the machine learning, the machine learning process executes the machine learning at a learning rate lower than a learning rate during the machine learning.

19. The device for seeking a workpiece holding form for a robot hand according to claim 3, wherein
during an operation after the machine learning, instead of the holding form generation process, the machine learning process generates the holding form based on the mounted state of the workpiece,
the device further comprises a result information storage unit configured to store the holding form generated by the machine learning process, the movement in the operation, and the evaluation score determined by the evaluation scoring process in association with each other during the operation after the machine learning, every time holding the workpiece with the robot hand, and
the machine learning process executes the machine learning again at predetermined timing after the machine learning by using the holding form generated by the machine learning process and stored in the result information storage unit in association with each other, the movement in the operation, and the evaluation score determined by the evaluation scoring process.

20. The device for seeking a workpiece holding form for a robot hand according to claim 4, wherein
during an operation after the machine learning, instead of the holding form generation process, the machine learning process generates the holding form based on the mounted state of the workpiece,
the device further comprises a result information storage unit configured to store the holding form generated by the machine learning process, the movement in the operation, and the evaluation score determined by the evaluation scoring process in association with each other during the operation after the machine learning, every time holding the workpiece with the robot hand, and
the machine learning process executes the machine learning again at predetermined timing after the machine learning by using the holding form generated by the machine learning process and stored in the result information storage unit in association with each other, the movement in the operation, and the evaluation score determined by the evaluation scoring process.
